(19) United States
(12) Patent Application Publication
(10) Pub. No.: US 2018/0240174 A1
(43) Pub. Date: Aug. 23, 2018

(54) SYSTEM AND METHOD FOR PROVIDING A GRATUITY

(71) Applicants: Chris Douglas, St. Louis, MO (US); Michael Foltz, St. Louis, MO (US)

(72) Inventors: Chris Douglas, St. Louis, MO (US); Michael Foltz, St. Louis, MO (US)

(21) Appl. No.: 15/435,446

(22) Filed: Feb. 17, 2017

(51) Int. Cl. G06Q 30/06; G06Q 30/00; G06Q 20/10

(52) U.S. Cl. CPC G06Q 30/0617; G06Q 20/102; G06Q 30/01

(57) ABSTRACT

A system for providing a gratuity is disclosed which has a server system having a listing of members that are available for a hospitality provider for providing information concerning travel and other activities, the server system for receiving information from one or more guests having access to the server system, the information comprising a gratuity amount to be paid to one or more of the members.

### BACKGROUND

This disclosure relates to a system and method for providing gratuity and more particularly to a system and method for providing gratuity to one or more individuals who assist a customer through online communication.

In an effort to increase guest experience and customer loyalty, the hospitality industry (hotels, hostels, tour operators) utilize a number of online communication channels including email, SMS, live chat and social messaging platforms to connect with and engage potential and returning guests prior to and during their travels. Online messaging platforms allow individuals to communicate with other individuals in a timely and convenient manner. Some popular public social messaging applications include Facebook® Messenger, Whatsapp, and Skype.

However, the most common method for communicating with businesses through direct messaging is through an application embedded in a businesses' website known know as live chat. The live chat application was originally created for customer support for large service providers and commercial websites. More recently, live chat has gained popularity as a more general purpose customer engagement tool for small businesses, including hospitality providers.

Research shows that real-time customer engagement through live chat implementations can increase conversions up to 30% in a traditional e-commerce experience where a customer service representative can answer simple questions regarding a product or service. Hospitality businesses currently see a much lower conversion rate than a traditional e-commerce experience or interaction. The average hotel website realizes less than a 2% conversion rate from reservation inquiries. As a result, hotels could increase their conversion rates significantly though real-time customer engagement. In addition to handling queries about reservations, hotels are using live chat and social messaging to engage with existing customers, provide advice about activities, restaurants, or events while staying in the area. As a result, website visitors and staff are often engaged in much longer conversations than those of a traditional e-commerce experience. However, one of the limitations of live chat is that once a live chat session has ended, there is no way to continue engaging the customer through the same conversation as they would be able to do through a social messaging platform.

With the rise of social messaging and real-time communication in general, customers now expect the quality and nature of online communication to be on par with the personal interactions they have with hotel staff. Because of this, customer-facing staff are now being tasked with maintaining a presence on live chat and social messaging platforms.

Because hospitality staff rely on tips, they are more likely to provide exemplary customer service through communication channels that allow them to receive gratuity. Live chat does not currently allow visitors to provide gratuity to hospitality staff members, so customers currently have to utilize other platforms to send a tip during an online conversation. For example, a website visitor could request the staff member's Facebook®, Paypal or Venmo account information to connect to the staff member. However, This would require leaving the live chat established at the website of the hospitality provider, at which point the business is no longer able to control continued engagement with the customer.

Another drawback with using outside payment platforms is that customers and hospitality staff may not have access to the same platforms. These platforms also have limitations with regional access and currency exchange. For example, Venmo is currently only available in the United States and U.S. currency has to be used.

As can be appreciated, there is a need to have a system and method for allowing a website visitor to submit gratuity to one or more staff members that have provided advice and assistance during an online chat session, without having to leave the session and use a third party platform. It would further be beneficial to have a system and method that allows a user to easily provide a tip or gratuity to more than one staff member, to select different tip amounts for each staff member, and to execute the payment for all selected tips in a single transaction.

### SUMMARY

In one form of the present disclosure, a system for providing gratuity is disclosed which comprises a server system having a listing of members that are available for a hospitality provider for providing information concerning travel and other activities, the server system for receiving information from one or more guests having access to the server system, the information comprising gratuity amount to be paid to one or more of the members.

The present disclosure is also directed to a system for providing a gratuity that has an online service which lists staff members who are available to provide information, support and advice concerning travel and other activities. The service allows guests to communicate directly with available staff members, to select individual gratuity amounts to be paid to one or more staff members, and to execute the payment to one or more staff members in a single transaction.

In another form of the present disclosure, a system for providing a gratuity comprises a server system having a listing of members that are available for a hospitality provider for providing information concerning travel and other activities, the server system for receiving information from a guest having access to the server system, the information comprising gratuity amount to be paid to one or more of the members, and a guest device of the guest having a screen and configured to access the server system, the guest device for transmitting the information comprising the gratuity amount to be paid to one or more of the members, and the guest device for receiving various screens from the server system.

In yet another form of the present disclosure, a method for providing a gratuity comprises the steps of navigating to a website of a hospitality provider, beginning a session with a staff member of the hospitality provider, saving the session, providing a gratuity to the staff member, paying the gratuity, reviewing the session, and exiting from the website

In light of the foregoing comments, it will be recognized that the present disclosure provides a system and method for providing gratuity to an individual staff member or a number of staff members that have been helpful during a live chat session or an online chat session.

The present disclosure provides a system and method for providing a gratuity to an individual staff member in which a payment method may be selected by a guest or a user.

The present disclosure provides a system and method for a gratuity that may have preassigned or suggested gratuity amounts for each staff member of a hospitality provider.

The present disclosure provides a system and method for providing a gratuity in which a suggested gratuity amount can be overridden to allow a guest to provide a custom gratuity amount.

The present disclosure provides a system and method for providing a gratuity that is easy to use and easy to provide a gratuity to a staff member of a hospitality provider who has assisted a guest.

The present disclosure is directed to a system and method for providing a gratuity which serves as a centralized site for a hospitality provider to provide a list of staff members associated with the hospitality provider who are capable and available to assist guests with various questions and concerns.

The present disclosure also provides a system and method for providing a gratuity which also provides a hospitality provider to link other individuals to the system who are members of other organizations other than hospitality provider to provide a broader range of subjects and activities.

The present disclosure is further directed to a system and method for providing a gratuity which allow guests to research events and activities with members associated with a hospitality provider and to provide a gratuity to each member for assistance with the research.

The present disclosure provides a system and method for providing a gratuity which is a flexible system in that a hospitality provider or a third-party booking engine may use the system and method of the present disclosure.

These and other advantages of the present system and method for providing a gratuity will become apparent after considering the following detailed specification in conjunction with the accompanying drawings, wherein:

### BRIEF DESCRIPTION OF THE DRAWINGS

FIG. 1 is a block diagram of a system for providing a gratuity constructed according to the present disclosure;

FIG. 2 is an illustration of a screen which may be presented during use of the system for providing a gratuity constructed according to the present disclosure;

FIG. 3 is an illustration of a screen which may be presented during use of the system for providing a gratuity constructed according to the present disclosure;

FIG. 4 is an illustration of a screen which may be presented during use of the system for providing a gratuity constructed according to the present disclosure;

FIG. 5 is an illustration of a screen which may be presented during use of the system for providing a gratuity constructed according to the present disclosure;

FIG. 6 is an illustration of a screen which may be presented during use of the system for providing a gratuity constructed according to the present disclosure;

FIG. 7 is an illustration of a screen which may be presented during use of the system for providing a gratuity constructed according to the present disclosure;

FIG. 8 is an illustration of a screen which may be presented during use of the system for providing a gratuity constructed according to the present disclosure;

FIG. 9 is an illustration of a screen which may be presented during use of the system for providing a gratuity constructed according to the present disclosure;

FIG. 10 is an illustration of a screen which may be presented during use of the system for providing a gratuity constructed according to the present disclosure;

FIG. 11 is an illustration of a screen which may be presented during use of the system for providing a gratuity constructed according to the present disclosure;

FIG. 12 is an illustration of a screen which may be presented during use of the system for providing a gratuity constructed according to the present disclosure;

FIG. 13 is an illustration of a screen which may be presented during use of the system for providing a gratuity constructed according to the present disclosure;

FIG. 14 is an illustration of a screen which may be presented during use of the system for providing a gratuity constructed according to the present disclosure; and

FIG. 15 is a flow chart diagram of an operation of a method for providing a gratuity constructed according to the present disclosure.

### DETAILED DESCRIPTION

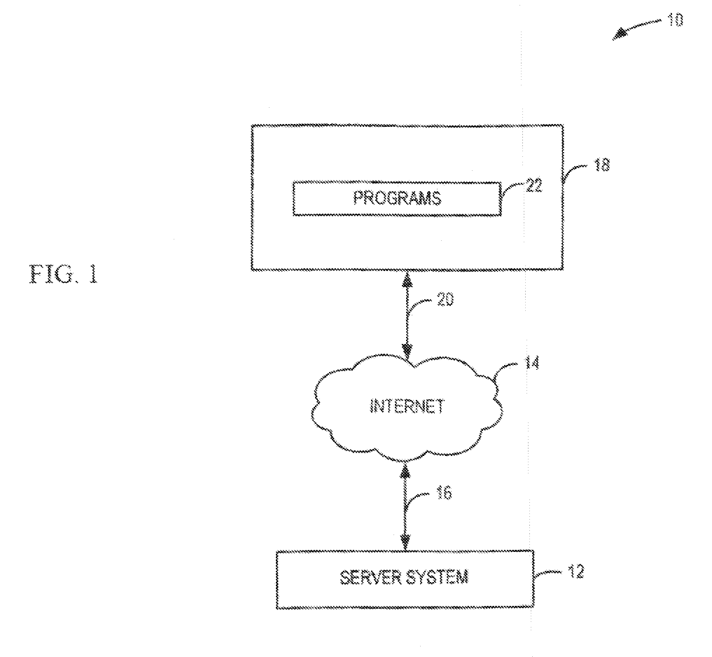

Referring now to the drawings, wherein like numbers refer to like items, number 10 identifies a system for providing a gratuity constructed according to the present disclosure. With reference now to FIG. 1, the system 10 is shown to comprise a management server system 12 that is connected to a communications network such as the Internet 14 via a connection 16. The server system 12 may comprise a computer network that is capable of storing software programs and data. The server system 12 may also host a website that may be accessed over the Internet 14. The server system 12 may comprise a single computer system or a number of computer systems grouped together. The server system 12 may include a database for storing information concerning staff members that are allowed to be available for a live chat session associated with a particular hospitality provider. The database may contain information such as a listing of staff members, contact information for a staff member, information concerning interests for a staff member, and historical information of a staff member. Further, by way of example only, the computer 12 may be a computer having a microprocessor, memory, a hard drive having stored thereon an operating system and other software, ports such as an USB port, input devices such as a mouse or a keyboard, a CD-ROM drive, and a floppy disk drive. Other ancillary devices may be included such as a printer, a scanner, a modem, a router, or other network devices that allow the server system 12 to be connected to the Internet 14. The connection 16 may take on various forms such as a telephone line, cable, ISDN lines, fiber optic lines, wireless connections, microwave, radio, satellites, or other connection devices or means.

A customer device 18, such as a computer, a tablet, a smart phone, or any other device which is capable of communicating with the server system 12, is also connected to the Internet 14 by a connection 20. The connection 20 may take on the same form or forms as the connection 16, but is typically a wireless connection or a WiFi connection. The customer device 18 has the capability of having various programs 22, such as software programs or software applications, resident or stored in the device 18. One of the programs may be a web browser that allows for sending and receiving information to and from the server system 12. Further, the user of the device 18 may also set up an account directly at a website associated with the server system 12. In this manner, a cloud based program at the server system 12 is provided.

By way of further example only, the customer device 18 may be a an iPod touch, a personal digital assistant (PDA), an iPad, a device that has WiFi connectivity, or other mobile communications device capable of sending and receiving data over a wireless network. Although not shown in any detail, the customer device 18 may have a microprocessor, memory, a hard drive having stored thereon an operating system and other software, input devices such as a mouse or a keyboard, a CD-ROM drive, and a floppy disk drive. Other ancillary devices may be included or attached to the customer device 18 such as a printer, a scanner, a modem, a router, or other network devices that allow the device 18 to be connected to the Internet 14. Further, although one customer device 18 is illustrated and discussed, it is possible and anticipated that more than one customer device 18 may be connected to the server system 12 over the Internet 14. It is also possible that a user of the system 10 can use different devices 18 to access the server system 12. For example, the user may not be near a computer and the user will have to use a smart phone to access the server system 12.

The server system 12 has a software platform or program therein that is designed to enhance and facilitate person-to-person connectivity. The server system 12 may have a website associated with it that has a web page or home page that acts as a portal to connect various guests, individuals, or members to the server system 12. Once each guest is connected to the server system 12, information may be displayed as a user interface to the guest. The user interface may contain relevant information that is displayed as a web page on a screen of the device 18. The information that may be displayed may include hospitality provider information, a listing of staff members associated with the hospitality provider, contact information of the staff members, interests of the staff members, and information concerning how helpful the staff members have been to other guests

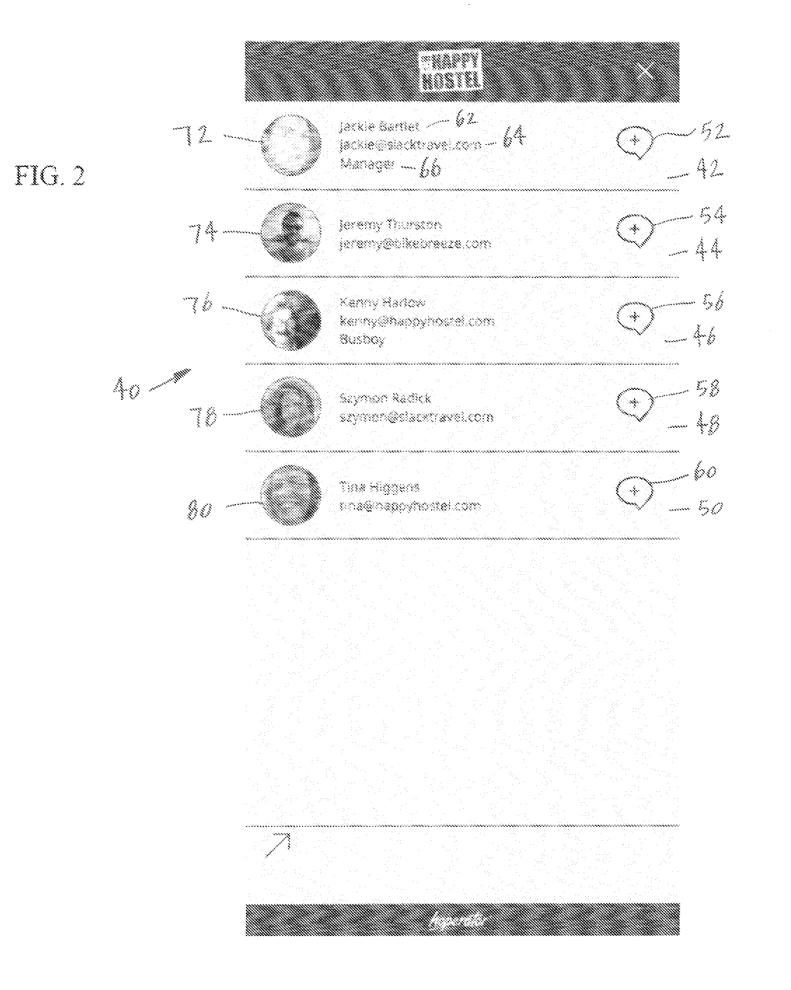

FIG. 2 illustrates a screen or a web page 40 that may be displayed on the device 18 that has accessed the website associated with the server system 12. The screen 40 is presented to a guest for the guest to be able to select one or more staff members 42, 44, 46, 48, or 50 that are available for a session or conversation. The session or conversation may be limited to a single subject, such as weather conditions, or it may be varied in that the guest may ask multiple questions about a potential visit to the location of the hospitality provider associated with the website of the server system 12. The screen 40 has a call button or icon 52, 54, 56, 58, and 60 associated with each staff member 42, 44, 46, 48, or 50, respectively. For example, if the guest would like to speak with only staff member 44 then the button 54 may be selected. Also, unlike a typical live chat application, if the guest wants to have a conversation with two or more staff members then two or more of the buttons 52, 54, 56, 58, and 60 may be selected. The guest can also type in a question and the question will be sent or submitted to all of the staff members 52, 54, 56, 58, and 60 associated with the hospitality provider. Other information, such as a name 62 of the staff member 42, a contact or email address 64 of the staff member, and a position 66 of the staff member 42 may be provided in the screen 40. Further, the system 10 is flexible in that staff members from other businesses may be linked to the system 10. For example, the staff member 48 is from a different business than the hospitality provider of the website of the server system 12. This may be beneficial when the guest needs to coordinate various services, as will be explained in detail herein.

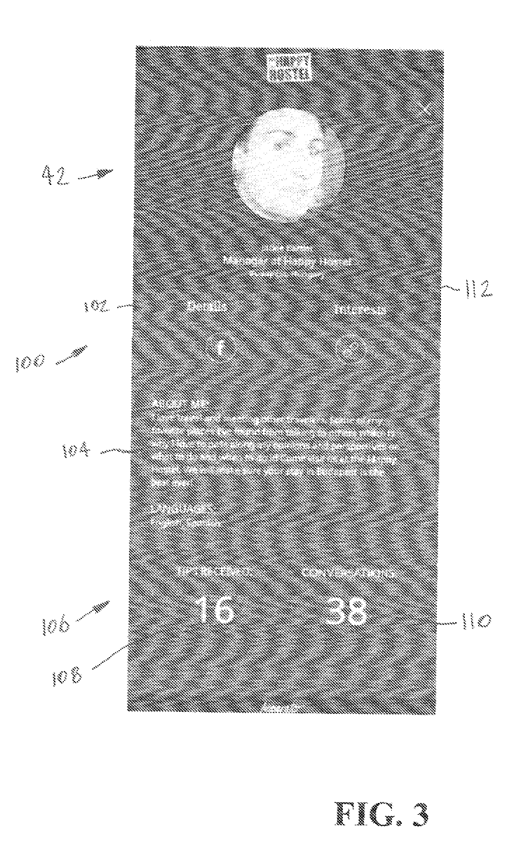

Also, prior to initiating a session, the guest can view profile information for each staff member 42, 44, 46, 48, or 50. In order to review profile information, the guest may select an icon 72, 74, 76, 78, or 80 associated with each of the staff members 42, 44, 46, 48, or 50. For example, if the icon 72 is selected, then a new screen 100 is presented to the guest, as is shown in FIG. 3. In the screen 100, a detail tab 102 includes information 104 concerning the staff member 42 including languages spoken. The screen 100 also includes an area 106 in which important accumulated numbers are provided. In a first box 108, the number of gratuities or tips is displayed and in a second box 110, the number of times a guest saved the staff member's conversations with the staff member is presented. Basically, the guest has created an account and now has access to the staff member to chat with the staff member at any time. The numbers presented in the boxes 108 and 110 provide a level of credibility for the staff member 42 that cannot be obtained from other sources. The server system 12 is capable of keeping track of the numbers provided in the boxes 108 and 110. In particular, if the staff member 42 has been employed at the hospitality provider for a number of years and the numbers displayed in the boxes 108 and 110 are low then the guest would be alerted that the staff member 42 may not be that helpful and another staff member 44, 46, 48, or 50 should be selected. However, on the other hand, if the numbers presented in the boxes 108 and 110 are large then the guest may want to engage the staff member 42 in a session.

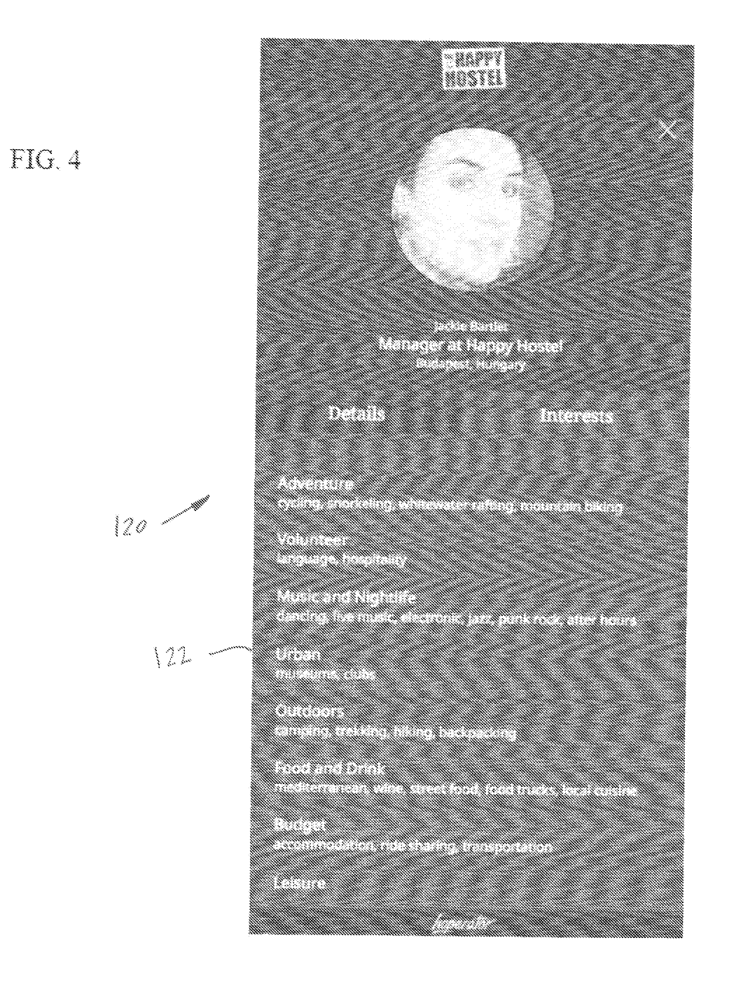

The screen 100 also has a tab 112 that may be selected to open a new screen 120, shown in FIG. 4. Referring now to FIG. 4, the screen 120 contains information 122 concerning the interests of the staff member 42. For example, the staff member 42 may be interested in a certain cuisine. If the guest is interested in that certain cuisine then the guest may ask the staff member 42 about restaurants in the area that the staff member 42 would suggest attending. The information 122 allows the guest to determine if the guest and the staff member 42 share common interests. Once the guest has determined that the staff member 42 may be a likely person to converse with, the staff member 42 may be selected by returning to the screen 40 and selecting the icon 52.

Once the icon 52 is selected, the staff member 42 is able to have a session or conversation with the guest. The staff member 42 will be able to provide information or services such as travel advice, take reservations, share places of interests, and disclose upcoming events and activities. During the session it may be determined that the guest may want to take a tour provided by a particular tour operator. In this event, if the tour operator is available on the website, the guest can initiate a session with the tour operator by selecting the icon 58 of the staff member 48. When this is done, the staff member 42 and the staff member 48 may be brought into the same session for the guest to coordinate a selected tour suggested by the staff member 42.

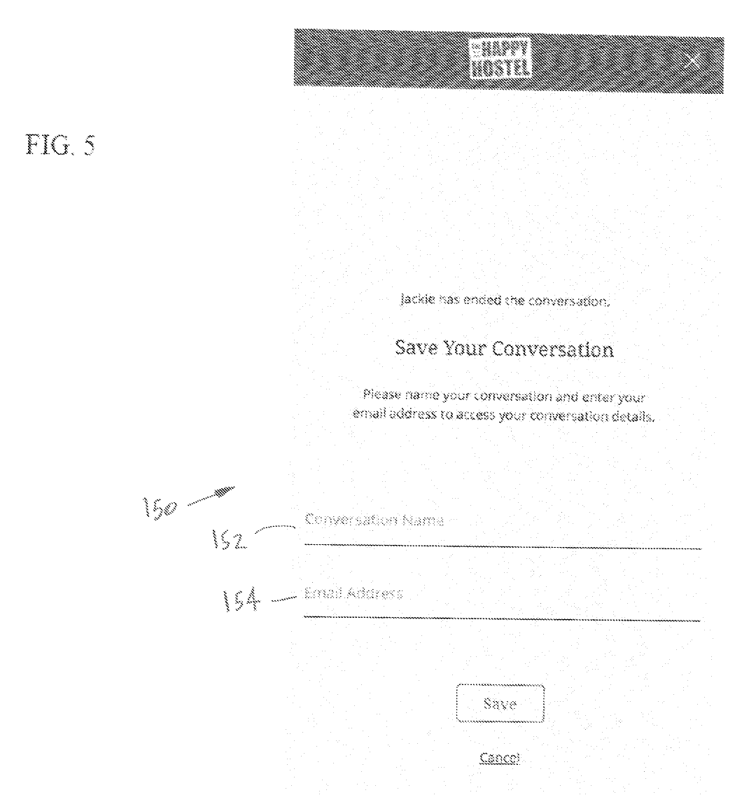

FIG. 5 illustrates a screen or a web page 150 that may be displayed on the device 18 that has accessed the website associated with the server system 12. The screen 150 is presented once a live chat session has ended or concluded. Once a live chat session has been concluded or a guest's requests have been answered, the staff member 42 may end the session. Ending the session prompts the screen 150 to be presented to the guest to save the session or exit the server system 12. The guest can enter a session name in a box 152 and an email address of the guest in a box 154 so that the session can be saved. Saving the session will enable the server system 12 to send a copy of the session to the guest to the email address entered by the guest. The copy of the session allows the guest to review the session and the details of the session at a later time. The guest can access this information as a web page at any time without creating an account. The guest can even continue the session or conversation with one or more of the staff members. For example, the staff member 42 may provide certain dates and times for a specific event that is of some interest to the guest. By being able to review the details of the session the guest is able to better plan their trip.

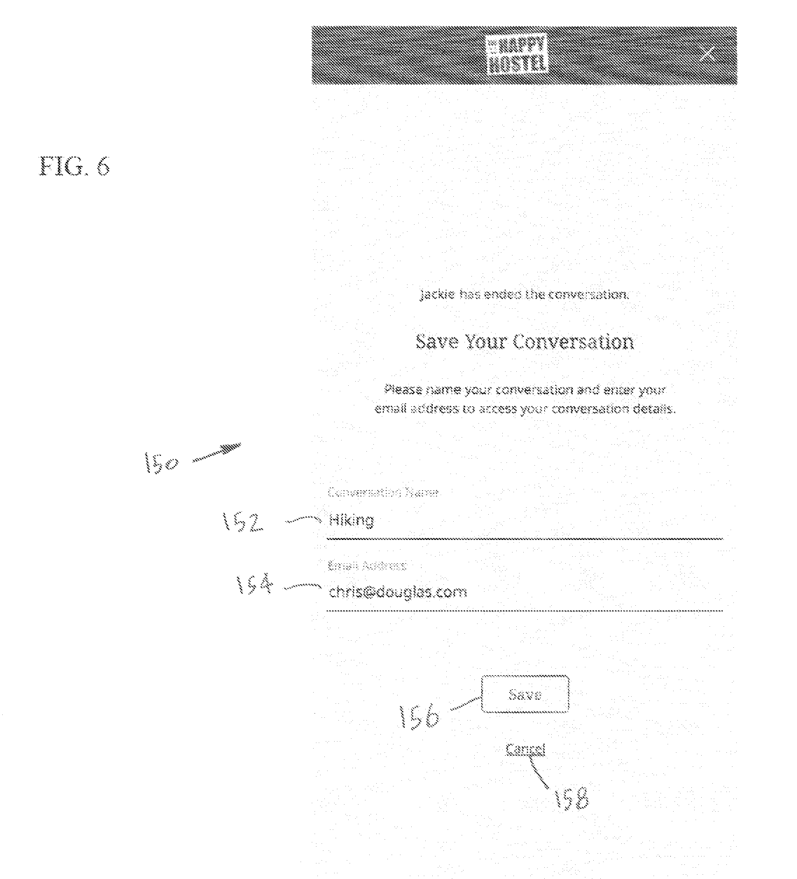

FIG. 6 demonstrates that the guest has entered the requested information into the boxes 152 and 154. Once entered, a save button 156 may be selected to save the session. If the guest decides not to save the session, a cancel button 158 may be selected.

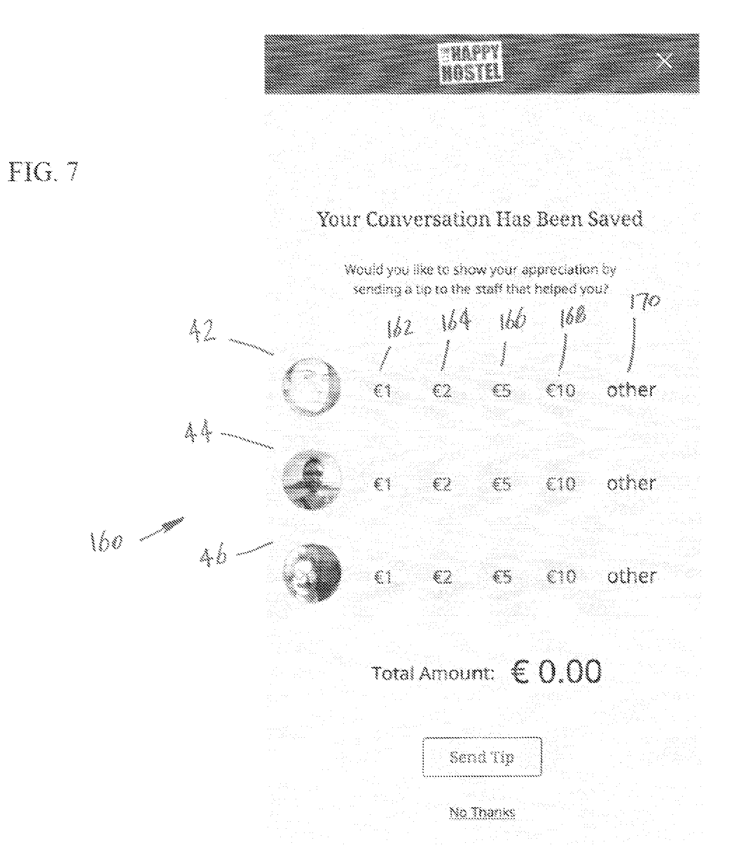

Once the guest has decided to either save the session or not, a new screen 160 is provided to the guest. The new screen 160 is depicted in FIG. 7. The screen 160 allows the guest to provide a gratuity to one or more of the staff members 42, 44, 46, 48, or 50 that the guest had a session. Only the staff members 42, 44, 46, 48, or 50 that the guest had a session with will be displayed in the screen 160. The server system 12 keeps track of the staff members 42, 44, 46, 48, and 50 that were present in the session. In this particular case, the staff members 42, 44, and 46 participated in the session with the guest. The guest is provided with the opportunity to leave a number preselected gratuity amounts 162, 164, 166, or 168 or a custom gratuity amount 170 to one or more of the staff members 42, 44, or 46.

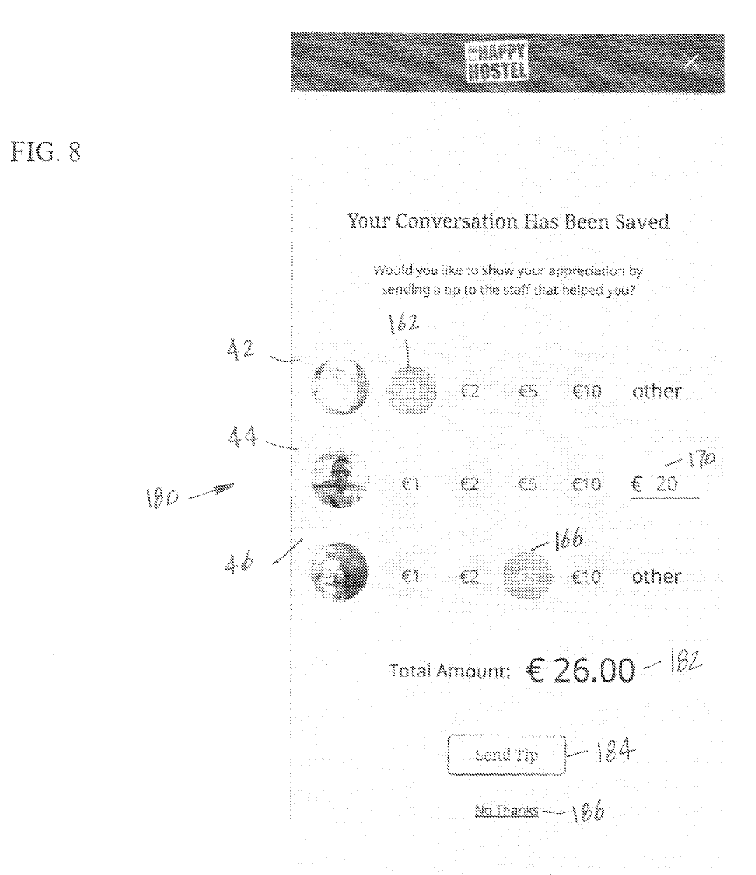

When the guest selects one or more of the gratuity amounts 162, 164, 166, 168, and 170, a screen 180, as illustrated in FIG. 8, is presented to the guest. In the screen 180, the guest has decided to provide the staff member 42 with the preselected amount 162, the staff member 44 with a custom amount 170, and the staff member 46 with the preselected amount 166. A box 182 is provided that totals the amounts for the guest to review. As can be appreciated, the gratuity amounts are determined by the guest based on how helpful the staff members 42, 44, and 46 were during the session. Once the guest is satisfied with the total presented in the box 182, an icon 184 may be selected to send and distributed the gratuities selected. The guest is also provided the option of not providing any gratuities by selection of an icon 186.

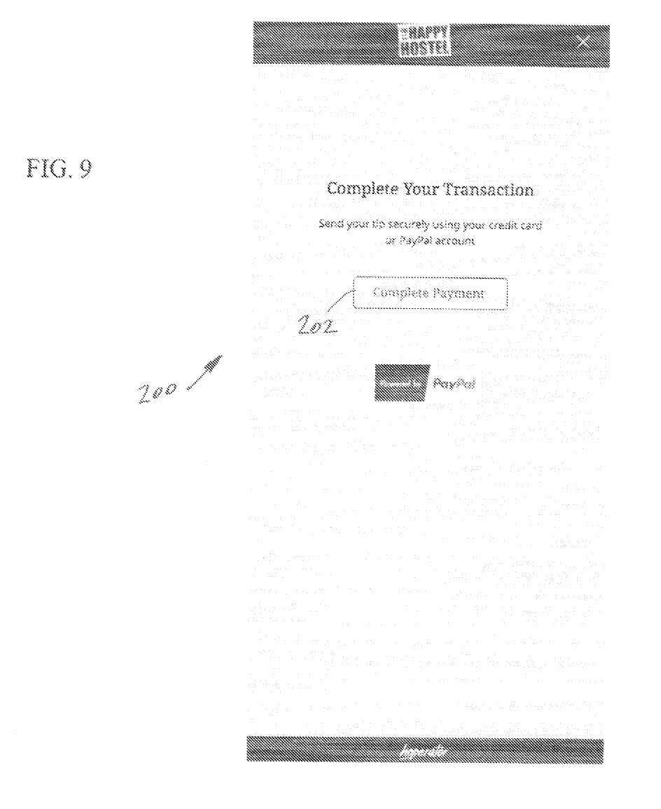

If the icon 184 was selected then the guest is provided a new screen 200, such as is shown in FIG. 9. The screen 200 is presented so that the guest may begin the payment process. In this particular case, a preselected payment provider has been contracted with to facilitate payment. An icon 202 is selected to take the guest to a website associated with the payment provider for transacting payment. Although not shown, the guest will be taken to a new website having a new screen in which the guest will go through a payment process. Once the payment process has been completed the guest will be taken back to the website of the hospitality provider associated with the server system 12.

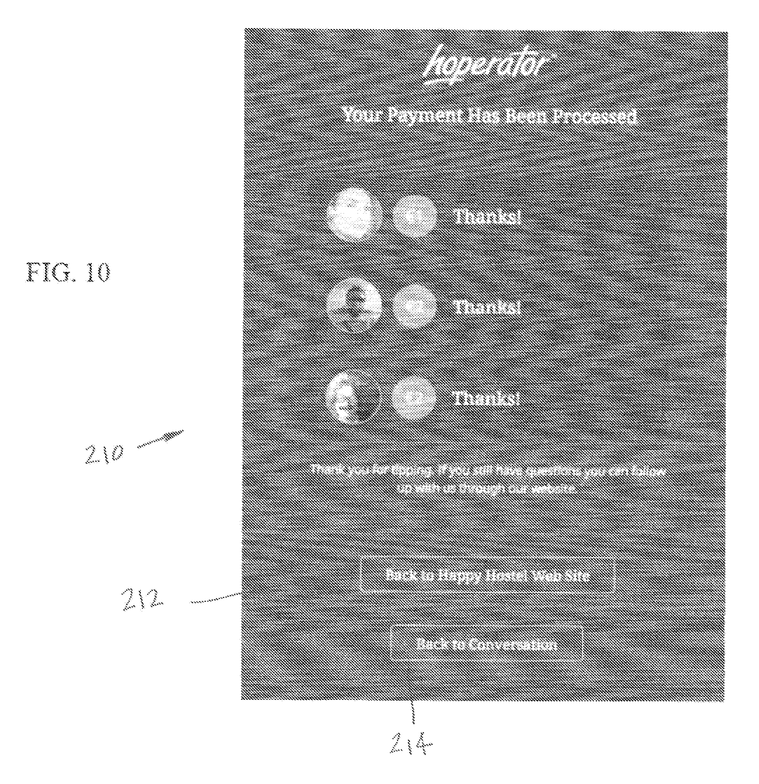

FIG. 10 illustrates a screen 210 that is presented to the guest once the payment transaction has been completed. In the screen 210 the guest may select an icon 212 that will direct the device 18 back to the website associated with the hospitality provider. An icon 214 is also provided in the screen 210 to allow the guest to return to the session in case the guest has other questions or concerns. The icon 214 is also provided in case the guest wants to adjust the previous provided gratuity or if the guest wants to provide a gratuity to another staff member.

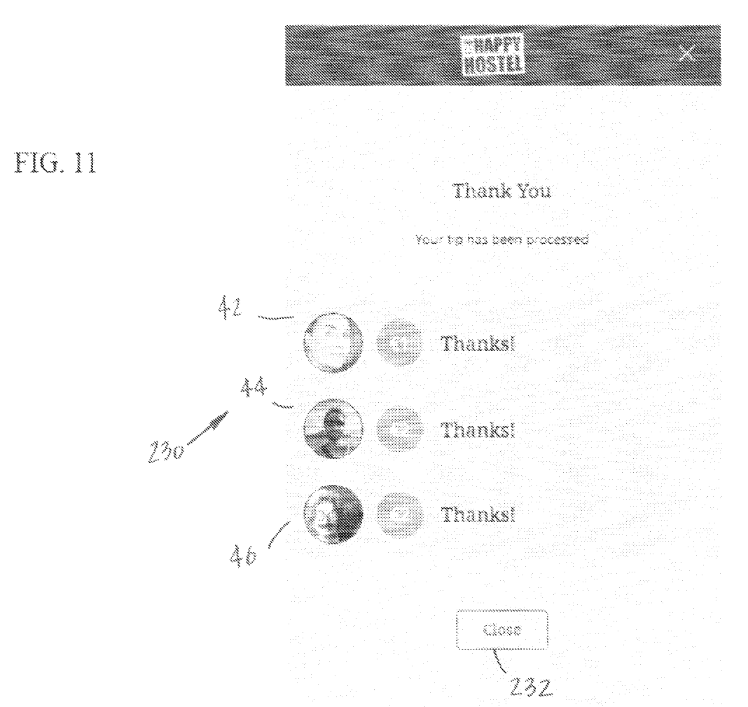

Referring now to FIG. 11, once a payment has been processed, the guest is provided a screen 230. The screen 230 shows the staff members 42, 44, and 46 that have been paid a gratuity and the amount of the gratuity paid and processed. At this point, the guest may select an icon 232 to close the session completely.

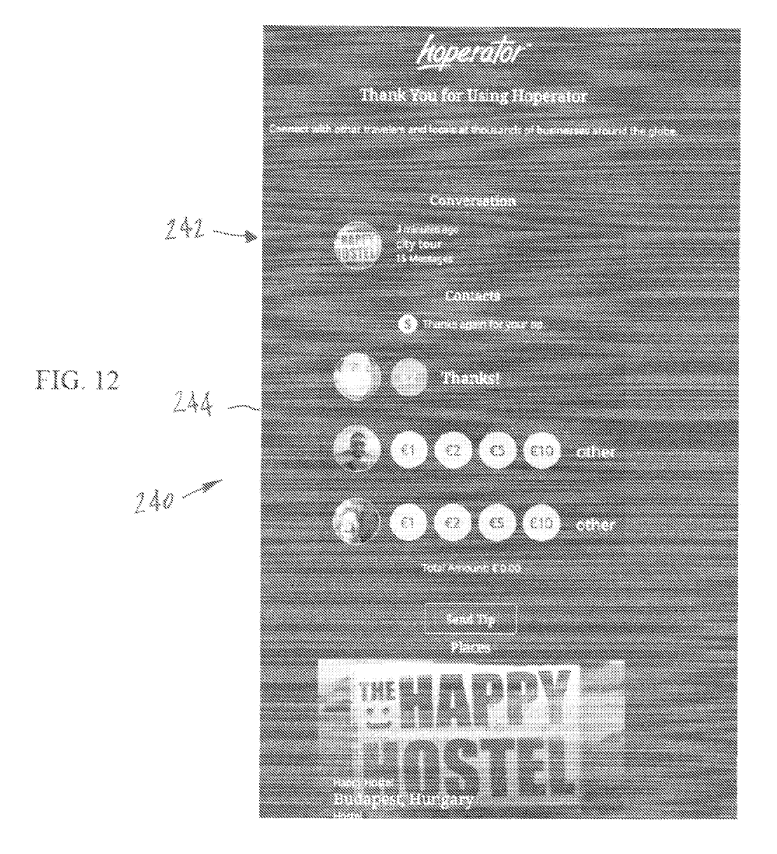

FIG. 12 illustrates a screen 240 which shows the session or conversation 242 that has been saved by the guest. Although the one session 242 is shown, it should be understood that the screen 240 may include all of the sessions that the guest may have had with the staff members of the particular hospitality provider. In this manner, the guest can review the session 242 in order to remember the contents of the session 242 or to reconnect with one or more of the staff members that were included in the session 242. The screen 240 also has an area 244 in which the previously provided gratuity amounts for each staff member included in the session 242 is displayed.

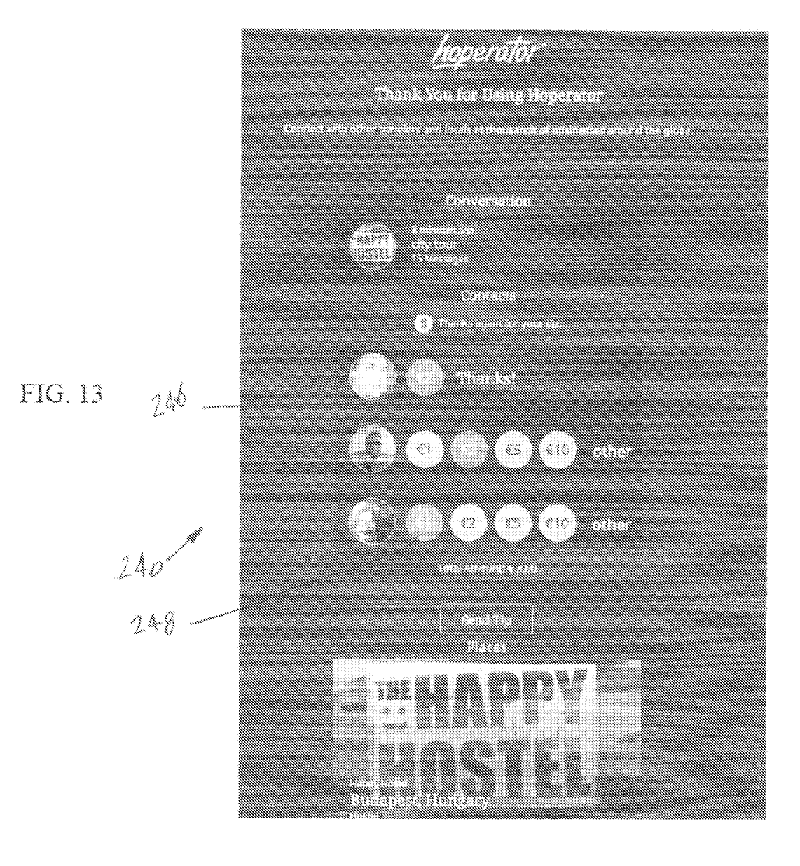

With reference now to FIG. 13, the screen 240 is shown to have the capability of sending additional gratuity amounts 246 and 248. In particular, the guest has decided to provide the gratuity amount 246 to the staff member 44 and the gratuity amount 248 to the staff member 46. In this manner, the guest can submit a gratuity amount after a session has been completed.

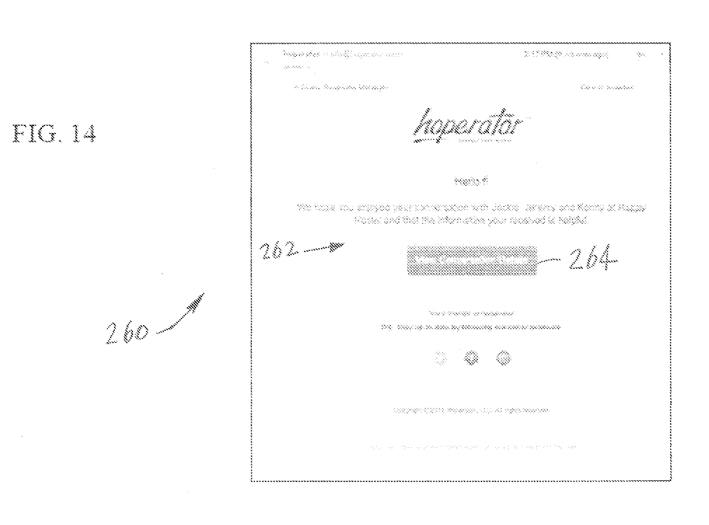

FIG. 14 is an example of a screen 260 containing an email 262 that may be generated and sent to the guest after the session has been completed or concluded. The email 262 has a box or icon 264 that may be selected to go to the saved session. The email 262 may be saved in the mailbox of the guest for future reference.

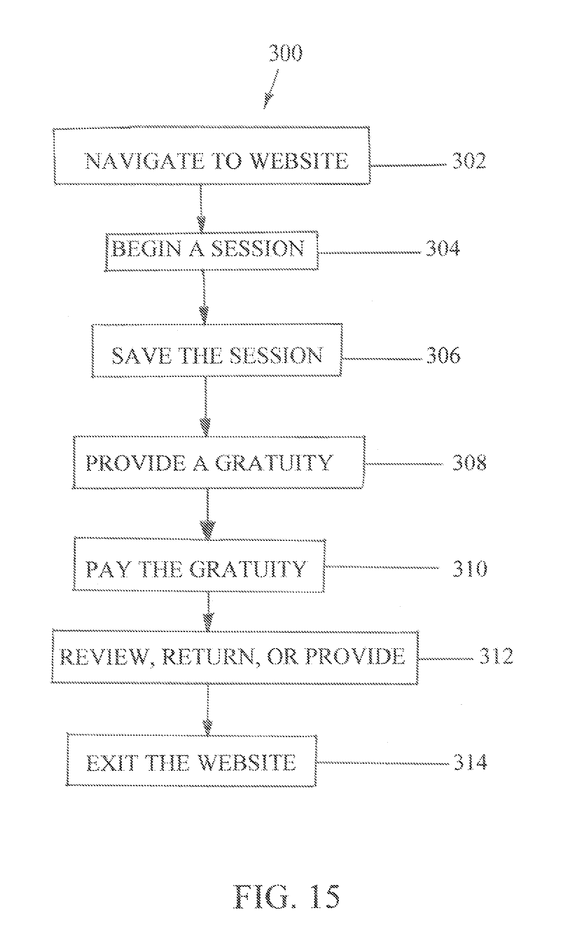

FIG. 15 is a flow chart diagram 300 of the general operation of the system 10. In an initial step 302, a guest will navigate to the website of the hospitality provider that is connected or associated with the server system 12. The guest may find the hospitality provider by use of various methods. For example, the guest may see an ad on a website that the system 10 is available and the user will be directed to the website of the server system 12 to review the website of the hospitality provider. The system 10 may also have an ad in a magazine having an QR (quick response) code that the guest may scan by use of the device 18 to be directed to the website of the hospitality provider, a booking agent, or other website. Once the guest has accessed the website the guest may open a screen, such as the screen 40 (FIG. 2), to begin a session with one or more of the staff members 42, 44, 46, 48, and 50. This is shown in a step 304. As has been indicated above, the guest is able to review details and interests of each staff member and also to view statistics concerning how many gratuities the staff member has received and how many sessions the staff member has been involved in with other guests. After a session has been completed, in a next step 306, the guest will be given the opportunity to save the session. For example, the screen 150 as illustrated in FIG. 5 provides the guest the opportunity to save the session. In a next step 308 the guest is able to provide or select a gratuity for one or more of the staff members that participated in the session. The screen 180 as shown in FIG. 8 would be an example of this. As has been previously indicated, the guest is able to choose from a number of preselected gratuity amounts or a custom gratuity amount. In a next step 310 the guest enters a payment for a payment provider. Reference is made to the screen 200 in FIG. 9 to show how this is accomplished. After payment has been processed, the guest may review a saved conversation, return to the website of the hospitality provider, or provide a gratuity to one or more of the staff members 42, 44, 46, 48 and 50 that were included in the session but that the guest did not initially provide a gratuity. This is indicated as being a step 312. In a last step 314, the guest exits the website or the device 18.

As has been described, the system 10 may be a service provided at a website of a hospitality provider, a booking engine, or some other website associated with the server system 12. The service and the user interfaces, such as the screens 40, 100, 120, 150, 160, 180, 200, 210, 230, 240, and 260 facilitate and allow guests of the system 10 to have a session or conversation with one or more available staff members. The sessions may be used to obtain information concerning upcoming events and activities near where the hospitality provided is located, to reserve a room, to obtain tour information, to reserve a spot for a tour, and for general information concerning the location to be traveled to by the guest. Once a session has been completed, the system 10 is capable of aggregating and facilitating payment of a gratuity to one or more of the staff members that participated in the session. Various preselected gratuity amounts are available for selection and a custom gratuity amount is also available for selection. Although the system 10 has been described as being for the use of a hospitality provider, it is contemplated and possible that the system 10 may be used for other providers such as a business, a website, or other provider in which a gratuity may be sent to an individual or individuals associated with the business, website, or other provider.

The order of execution or performance of the operations in embodiments of the system and method illustrated and described herein is not essential, unless otherwise specified. That is, the operations may be performed in any order, unless otherwise specified, and embodiments of the system and method may include additional or fewer operations than those disclosed herein. For example, it is contemplated that executing or performing a particular operation before, contemporaneously with, or after another operation is within the scope of aspects of the present disclosure.

Having described the system 10 in detail, it will be apparent that modifications and variations are possible without departing from the scope of aspects of the disclosure as defined in the appended claims. As various changes could be made in the above constructions, products, systems, and methods without departing from the scope of aspects of the disclosure, it is intended that all matter contained in the above description and shown in the accompanying drawings shall be interpreted as illustrative and not in a limiting sense.

From all that has been said, it will be clear that there has thus been shown and described herein a system and method for providing a gratuity which fulfills the various advantages sought therefore. It will become apparent to those skilled in the art, however, that many changes, modifications, variations, and other uses and applications of the subject system and method for providing a gratuity are possible and contemplated. All changes, modifications, variations, and other uses and applications which do not depart from the spirit and scope of the disclosure are deemed to be covered by the disclosure, which is limited only by the claims which follow.

What is claimed is:

1. A system for providing a gratuity comprising:
a server system having a listing of members that are available for a hospitality provider for providing information concerning travel and other activities, the server system for receiving information from one or more guests having access to the server system, the information comprising a gratuity amount to be paid to one or more of the members.

2. The system for providing a gratuity of claim 1 further comprising a number of sessions that a member has been involved.

3. The system for providing a gratuity of claim 1 further comprising a number of gratuities received by a member.

4. The system for providing a gratuity of claim 1 further comprising a listing of details for each member of the hospitality provider.

5. The system for providing a gratuity of claim 1 further comprising a listing of interests for each member of the hospitality provider.

6. The system for providing a gratuity of claim 1 wherein the server system may initiate a session with one or more of the members of the hospitality provider.

7. The system for providing a gratuity of claim 1 wherein the server system may initiate a session with one or more of the members and the server system is capable of keeping track of the gratuity amount paid to each of the members.

8. The system for providing a gratuity of claim 1 wherein the gratuity amount may be a preselected amount.

9. A system for providing a gratuity comprising:
a server system having a listing of members that are available for a hospitality provider for providing information concerning travel and other activities, the server system for receiving information from a guest having access to the server system, the information comprising a gratuity amount to be paid to one or more of the members; and
a guest device of the guest having a screen and configured to access the server system, the guest device for transmitting the information comprising the gratuity amount to be paid to one or more of the members, and the guest device for receiving various screens from the server system.

10. The system for providing a gratuity of claim 9 wherein the guest may initiate a session through the use of the guest device with one or more of the members.

11. The system for providing a gratuity of claim 9 wherein the gratuity amount may be a preselected amount.

12. The system for providing a gratuity of claim 9 wherein the gratuity amount may be a custom amount.

13. The system for providing a gratuity of claim 9 wherein the guest may initiate a session with one or more of the members and the server system is capable of keeping track of the gratuity amount paid to each of the members

14. The system for providing a gratuity of claim 9 wherein each member has a listing of a number of gratuities received.

15. The system for providing a gratuity of claim 9 wherein the guest may initiate a session through the use of the guest device with one or more of the members and wherein each member has a listing of a number of sessions initiated.

16. A method for providing a gratuity comprising the steps of navigating to a website of a hospitality provider, beginning a session with a staff member of the hospitality provider, saving the session, providing a gratuity to the staff member, paying the gratuity, reviewing the session, and exiting from the website.

17. The method for providing a gratuity of claim 16 further comprising the step of beginning the session with another staff member.

18. The method for providing a gratuity of claim 17 further comprising the step of providing a gratuity to the other staff member.

19. The method for providing a gratuity of claim 16 wherein the reviewing the session step further comprises the step of returning to the website.

20. The method for providing a gratuity of claim 16 wherein the reviewing the session step further comprises the step of providing a gratuity to another staff member.
